(19) United States
(12) Patent Application Publication
(10) Pub. No.: US 2026/0136171 A1
(43) Pub. Date: May 14, 2026

(54) Mobile Device Incognito Mode with Automatic Reversion to Default Operational Mode

(71) Applicant: Google LLC, Mountain View, CA (US)

(72) Inventors: David Kleidermacher, Mountain View, CA (US); Sathish Karunakaran, Los Altos, CA (US); Vivin A. Williams, Mountain View, CA (US); Shishir Agarwal, Mountain View, CA (US); Roger Piqueras Jover, Brooklyn, NY (US)

(73) Assignee: Google LLC, Mountain View, CA (US)

(21) Appl. No.: 19/115,557

(22) PCT Filed: Oct. 28, 2022
(86) PCT No.: PCT/US2022/078910

§ 371 Date: Mar. 26, 2025

(51) Int. Cl. H04W 8/18

(52) U.S. Cl. CPC H04W 8/18

(57) ABSTRACT

A method for a UE to temporarily operate in an incognito mode includes detecting a trigger to do so at a time when the UE is operating in a default mode in which a first operational eSIM profile having a first subscriber identifier is active in the UE's eSIM and responsively (i) transitioning the UE to the incognito mode, and (ii) after a time period, automatically reverting the UE back to the default mode. The transitioning could involve deactivating the first operational eSIM profile and activating in its place a second eSIM profile having a second identifier, and the automatically reverting could involve deactivating the second operational eSIM profile and reactivating the first operational eSIM profile in its place. Further, the trigger to enter the incognito mode could be location and/or time, among other possibilities.

### BACKGROUND

User equipment devices (UE) such as cell phones, tablet computers, and other devices typically have one or more identifiers that may facilitate wireless communication service. For instance, a UE may have one or more hardware identifiers that uniquely identify the UE itself, and the UE may also have one or more subscriber identifiers that uniquely identify a subscription that the UE or a user of the UE has with a mobile network operator (MNO). When such a UE initially powers on or otherwise enters into wireless coverage provided by the MNO or by a roaming partner, the UE may acquire connectivity by engaging in an attachment process, which may involve the UE transmitting an attach request carrying one or more of its identifiers, the MNO using the one or more identifiers as a basis to authenticate the UE for service, and the MNO making a record of where the UE is operating so that the MNO can thereafter page and otherwise signal to the UE.

### SUMMARY

In accordance with the present disclosure, a user's UE could be configured to temporarily operate in an incognito mode. Temporarily operating in the incognito mode could involve transitioning from operating with a default subscriber profile to operating instead with an incognito subscriber profile and then, after a period of time of operating with the incognito subscriber profile, automatically reverting to operate with the default subscriber profile.

Each subscriber profile in this arrangement could have a different respective subscriber identifier, with the default profile having a default subscriber identifier associated with a service subscription of the UE and the incognito profile having an incognito subscriber identifier that is different than the default subscriber identifier and is not associated with the service subscription of the UE. Temporarily operating with the incognito mode could therefore involve temporarily operating with the incognito subscriber identifier, which may help to avoid association with the service subscription of the user.

Further, temporarily operating in the incognito mode could involve operating with one or more other temporarily assigned identifiers and then, after passage of the period of time, automatically reverting to operate with one or more default identifiers. For example, if the UE has a permanent hardware identifier, temporarily operating in the incognito mode could involve operating with one or more incognito hardware identifiers rather than with the permanent hardware identifier and then, after passage of the period of time, automatically reverting to operate with the permanent hardware identifier rather than with the incognito identifier. As another example, if the UE supports voice telephony service and has an assigned default telephone number (e.g., as part of the default subscriber profile), temporarily operating in the incognito mode could involve operating with an incognito phone number (e.g., as part of the incognito profile) rather than with the default telephone number and then, after passage of the period of time, automatically reverting to operate with the default telephone number rather than with the incognito telephone number.

Accordingly, in one respect, disclosed is a method to enable a temporary incognito mode for a UE that has an embedded subscriber interface module (eSIM). The method could include detecting a trigger for the UE to temporarily operate in an incognito mode, the detecting of the trigger occurring when the UE is operating in a default mode in which a first operational eSIM profile having a first subscriber identifier is active in the eSIM. Further, the method could include, responsive to detecting the trigger, (i) the UE transitioning from operating in the default mode to operating in the incognito mode and (ii) after operating in the incognito mode for a time period, the UE automatically reverting from operating in the incognito mode to operating in the default mode.

In this method, the transitioning from operating in the default mode to operating in the incognito mode could include (a) deactivating the first operational eSIM profile in the eSIM and activating in the eSIM a second operational eSIM profile in place of the first operational eSIM profile, the second operational eSIM profile having a second subscriber identifier different than the first subscriber identifier and having not been previously active in the eSIM, and (b) per the second operational eSIM profile, using the second subscriber identifier to facilitate engaging in wireless communication service. Further, the act of automatically reverting from operating in the incognito mode to operating in the default mode could include (a) deactivating the second operational eSIM profile in the eSIM and reactivating in the eSIM the first operational eSIM profile in place of the second operational eSIM profile, and (b) per the first operational eSIM profile, using the first subscriber identifier to facilitate engaging in wireless communication service.

In another respect, disclosed is a UE. The UE includes a processor, non-transitory data storage, an eSIM, a transceiver, and an antenna structure supporting air interface communication. Further, the non-transitory data storage holds program instructions executable by the processor to cause the UE to carry out operations such as those noted above. Namely, the operations could include detecting a trigger for the UE to temporarily operate in an incognito mode, the detecting of the trigger occurring when the UE is operating in a default mode in which a first operational eSIM profile having a first subscriber identifier is active in the eSIM. Further, the operations could include, responsive to detecting the trigger, (i) transitioning from operating in the default mode to operating in the incognito mode, and (ii) after operating in the incognito mode for a time period, automatically reverting from operating in the incognito mode to operating in the default mode.

As discussed above, the operation of transitioning could include (a) deactivating the first operational eSIM profile in the eSIM and activating in the eSIM a second operational eSIM profile in place of the first operational eSIM profile, wherein the second operational eSIM profile has a second subscriber identifier different than the first subscriber identifier and has not been previously active in the eSIM, and (b) per the second operational eSIM profile, using the second subscriber identifier to facilitate engaging in wireless communication service. Further the operation of automatically reverting could include (a) deactivating the second operational eSIM profile in the eSIM and reactivating in the eSIM the first operational eSIM profile in place of the second operational eSIM profile, and (b) per the first operational eSIM profile, using the first subscriber identifier to facilitate engaging in wireless communication service.

In yet another respect, disclosed is a non-transitory computer-readable medium having stored thereon instructions executable by a processor to cause a UE to carry out operations such as those discussed above.

In still another respect, disclosed is a system that includes various means for carrying out each of the operations described herein.

These as well as other aspects, advantages, and alternatives will become apparent to those of ordinary skill in the art by reading the following detailed description, with reference where appropriate to the accompanying drawings. Further, it should be understood that the descriptions provided in this summary and below are intended to illustrate the invention by way of example only and not by way of limitation.

### BRIEF DESCRIPTION OF THE DRAWINGS

FIG. 1 is a simplified block diagram of an example UE.

FIG. 2 is a simplified block diagram of an example network arrangement for serving the UE with cellular wireless communications.

FIG. 3 is a simplified block diagram of an example network arrangement for provisioning an operational eSIM profile into an eSIM of a UE.

FIG. 4 is a simplified block diagram of an example network arrangement supporting temporary incognito service.

FIG. 5 is a simplified block diagram of an example incognito server.

FIG. 6 is a flow chart depicting an example method.

### DETAILED DESCRIPTION

Example methods, devices, and systems are described herein. It should be understood, however, that any disclosed embodiment is not necessarily to be construed as preferred or advantageous over other embodiments unless stated as such. Further, it should be understood that variations from the specific arrangements and processes disclosed are possible. For instance, various disclosed entities, components, connections, operations, and other elements could be added, omitted, distributed, replicated, re-located, re-ordered, combined, or changed in other ways. In addition, it will be understood that various disclosed technical operations could be implemented at least in part by a processing unit programmed to carry out the operations or to cause one or more other entities to carry out the operations.

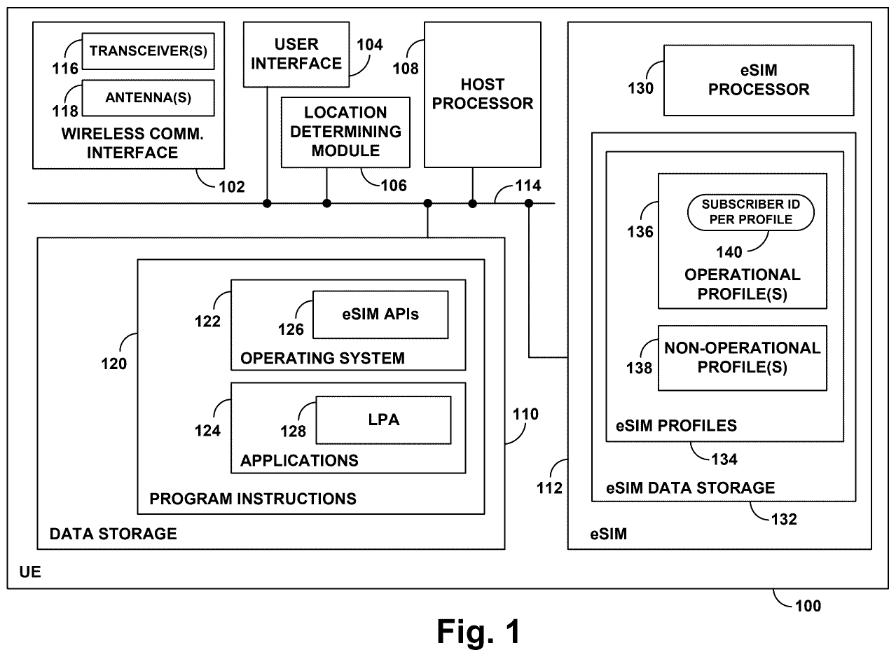

Referring to the drawings, as noted above, FIG. 1 is a simplified block diagram of an example UE 100. This example UE includes a wireless communication interface 102, a user interface 104, a location-determining module 106, a host processor 108, non-transitory data storage 110, and an eSIM 112, all of which may be communicatively linked together by a system bus or other connection mechanism 114. Other arrangements could be possible as well, including for instance, dedicated connections (e.g., serial interfaces) to facilitate secure communication between certain components, such as between the host processor 108 and the eSIM 112, among other possibilities.

The wireless communication interface 102 could include one or more transceivers 116 compliant with one or more radio communication protocols, including possibly one or more cellular radio access technologies (RATs) such as Long Term Evolution (LTE) and/or 5G New Radio (5G NR), and/or one or more wireless wide area network technologies such as WiFi or others. Each such transceiver may include a transmit/receive chain having a respective modem, amplifiers, and other components. Further, the wireless communication interface 102 could include one or more antenna structures 118 that interwork with the one or more transceivers and support air interface communication with serving network infrastructure.

The user interface 104 could include one or more components to facilitate interaction with a user of the UE 100. These components could include user output components such as a display screen, a sound speaker, indicator lights, and a haptic feedback mechanism, and user input components such as a touch screen, a microphone, and a keypad, among other possibilities.

The location-determining module 106 could be a Global Navigation Satellite System (GNSS) receiver, such as a Global Positioning System (GPS) receiver, which could facilitate determining geolocation of the UE 100. Such a module could operate by receiving signals from satellites and carrying out or triggering a triangulation process or the like, to determine with a high level of granularity the geographic location of the UE. The location-determination module 106 may also take other forms, possibly configured to use WiFi signaling or other signaling to facilitate determining the UE's location.

The host processor 108 could comprise one or more general purpose processors (e.g., one or more microprocessors, etc.) and/or one or more special-purpose processors (e.g., application-specific integrated circuits, etc.) Further, the non-transitory data storage 110 could comprise one or more volatile and/or non-volatile storage components (e.g., read only memory, random access memory, flash storage, cache memory, etc.), possibly integrated in whole or in part with the host processor.

As shown, the data storage 110 could store program instructions 120 including an operating system 122 and applications 124, with the program instructions 120 being executable by the host processor 108 to carry out various UE operations. As further shown in the example arrangement, the operating system 122 could define a set of eSIM application programming interfaces (APIs) 126, and the applications 124 could include a local profile assistant (LPA) 128 configured to make use of the eSIM APIs 126 as a basis to interact with the eSIM 112, such as to send commands to cause the eSIM 112 to take various actions.

The eSIM 112 could take the form of secure element (e.g., dedicated system on a chip (SoC)), particularly an embedded universal integrated circuit card (eUICC), which may be soldered or otherwise mounted to a system board of the UE and may serve to hold and manage eSIM profiles. The eSIM 112 may include an eSIM processor 130 and eSIM data storage 132. Further, while not shown, the eSIM 112 may include a communication interface through which to engage in direct, secure communication with the host processor 108. The eSIM processor 130 could include one or more general purposes processors and/or one or more special-purpose processors, and the eSIM data storage 132 could include one or more non-transitory storage components, which could hold program instructions executable by the eSIM processor 130 to carry out various eSIM operations. The eSIM could also have an eSIM identifier or eUICC identifier, known as an EID, which uniquely identifies the eSIM.

As further shown, the eSIM data storage 132 could store or be configured to store one or more eSIM profiles 134. Each eSIM profile could be a respective set of data that enables the UE to be served by a particular MNO (i.e., an actual MNO or a virtual mobile network operator (MVNO)). This could include data and applets, such as one or more network access applications that provide authorization to access the MNO's network and various network access data such as encryption keys and definitions of security algorithms that could enable the MNO's network to authenticate the UE. Further, the eSIM profile might also contain other data, such as a preferred roaming list (PRL) that could enable the UE to search for and discover coverage of the MNO's network and coverage of roaming partners, as well as other application logic, among other possibilities.

As shown, the eSIM profiles 134 may include one or more non-operational eSIM profiles 136 and one or more operational eSIM profiles 138. A non-operational eSIM profile 136 is a bootstrap or provisioning profile that is not tied to a particular service subscription with an MNO but that enables the UE to connect with and be served by an MNO to download and install an operational eSIM profile. An operational eSIM profile 138, on the other hand, is specific to an MNO service subscription and contains data and application logic that enables the UE to be served by the MNO in accordance with that service subscription. Typically, a user would enter into a service subscription contract with an MNO to have the MNO serve the user's UE, and a profile-provisioning system of the MNO would then provision the UE's eSIM with an operational eSIM profile tied to that service subscription.

As also shown, each of the one or more operational eSIM profiles 138 stored in the eSIM 112 has respective subscriber identifier 140, which may uniquely identify the associated service subscription and may further serve to identify the eSIM profile. An example of such a subscriber identifier is Subscription Permanent Identifier (SUPI) or more particularly an International Mobile Subscriber Identity (IMSI). An IMSI is an internationally standardized unique number including a mobile country code (MCC) (identifying the country of service), a mobile network code (MNC) (identifying the serving MNO), and mobile subscriber identification number (MSIN) (identifying the subscriber of the MNO).

When a user subscribes with an MNO to have the MNO serve the user's UE, the MNO may assign to the UE's subscription a respective IMSI and establish for the UE an eSIM profile having that IMSI tied to the user's service subscription. For instance, the MNO may have a pool of IMSIs authorized by an international standards body, and the MNO may select and assign to the user's subscription one of those IMSIs and establish for the user an operational eSIM profile containing the assigned IMSI and containing associated network access data, and the MNO may then arrange to have that eSIM profile installed in the eSIM of the user's UE. Further, the MNO may register associated data, such as the assigned IMSI and the network access data, in the MNO's network, such as at an authentication center and/or associated subscriber profile store, to allow the MNO to later authenticate the UE when the UE seeks to connect for service.

In addition, each of the one or more operational eSIM profiles 138 may also have one or more other identifiers. For instance, an operational eSIM profile may also store a phone number of the UE, useable to engage in telephony services such as voice calling and/or text messaging. For example, an operational eSIM profile may store a Mobile Station Integrated Services Digital Network (MSISDN) number, which is an internationally standardized unique phone number including a country code (CC), a national destination code (NDC), and a subscriber number (SN). When a user subscribes with an MNO to have the MNO serve the user's UE, the MNO may assign to the user's UE an MSISDN (perhaps with the subscriber number ported from another service subscription) and may store that MSISDN in the associated operational eSIM profile that gets installed in the UE's eSIM and registered in the MNO's network.

When the eSIM 112 contains one or more operational eSIM profiles 138, each operational eSIM profile could be set as either active or inactive and could be toggled between those two states. For instance, the LPA 128 may make use of the eSIM APIs 126 to activate or deactivate a given operational eSIM profile, and the eSIM 112 may accordingly flag that operational eSIM profile as either active or inactive. When an operational eSIM profile is active, the UE could accordingly make use of that operational eSIM profile as a basis to enable the UE to be served by the associated MNO in line with associated service subscription. For instance, when the UE initially powers on or otherwise enters into coverage of the MNO, the UE could obtain the IMSI and network access data from the active operational eSIM profile and could transmit that information to the MNO to facilitate authentication of the UE, as a condition for connecting with and being served by the MNO.

The LPA 128 may allow just one operational eSIM profile to be active at any given time in the eSIM 112. If the eSIM 112 contains multiple operational eSIM profiles, the LPA 128 may allow switching between those operational eSIM profiles, deactivating one and activating another in its place. Alternatively, the LPA 128 may support a multi-profile implementation, where two or more operational eSIM profiles are active at once, and may designate one of the operational eSIM profiles as a primary operational eSIM profile to be used for wireless communication service.

Though not shown in FIG. 1, the example UE 100 itself also has a permanent hardware identifier, which may uniquely identify the UE. Examples of such a hardware identifier include a Mobile Equipment Identifier (MEID) and an International Mobile Equipment Identity (IMEI), each being a globally unique identifier that indicates the manufacturer and serial number of mobile station equipment. A UE manufacturer may have a pool of such unique hardware identifiers authorized by an international standards body. When manufacturing the example UE 100, the manufacturer may then select and assign to the UE one of those hardware identifiers and permanently record the assigned hardware identifier in the UE. When a user subscribes with an MNO to have the MNO serve the UE, the MNO may also register in its network the UE's hardware address, which the MNO might also use as a basis to later authenticate the UE when the UE seeks to connect for service.

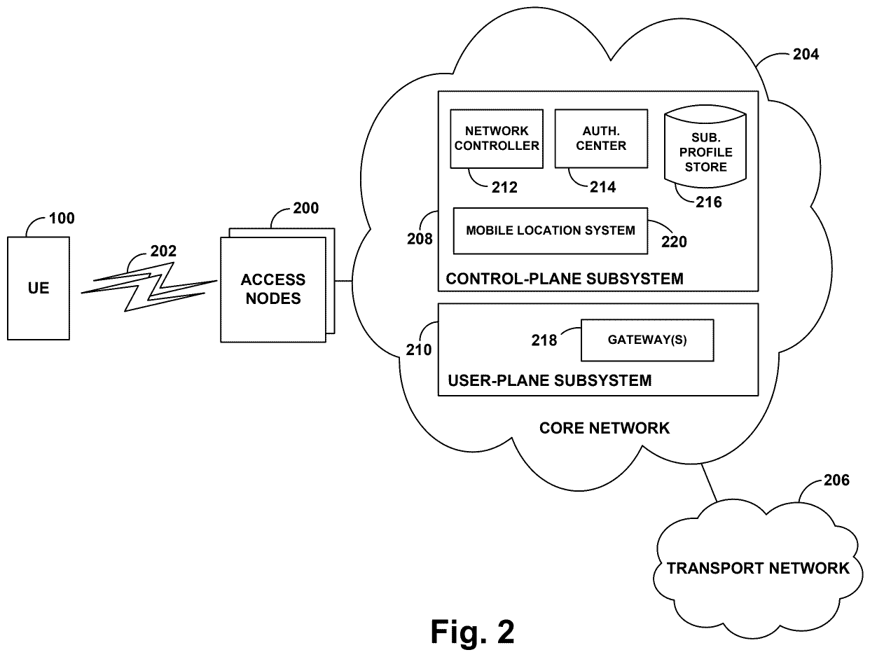

FIG. 2 is a simplified block diagram illustrating an example network arrangement in which the example UE 100 may be served with cellular wireless communication service. As shown, the example arrangement includes multiple access nodes 200, such as evolved Node-Bs (eNBs), each providing a respective wireless coverage area 202 in which to serve UEs. Each such coverage area 202 could be defined on one or more radio frequency (RF) carriers spanning a range of frequency bandwidth and could be frequency division duplex (FDD), with uplink and downlink operating on separate frequencies, or time division duplex (TDD), with uplink and downlink being multiplexed over time on the same frequency as each other. Further, each coverage area 202 could be defined in accordance with a standard RAT such as one of those noted above, providing various air interface control channels and bearer channels, to facilitate carrying control signaling and bearer communications between UEs and the access node.

As further shown, each access node sits as a node on an MNO's core network 204, which in turn provides connectivity with a transport network 206 such as the internet. As shown, the core network 204 includes a control-plane subsystem 208 and a user-plane subsystem 210. Further, as shown, the control-plane subsystem 208 may include a network controller 212, an authentication center 214, and a subscriber profile store 216, and the user-plane subsystem 210 may include one or more gateways 218 for conveying user-plane data such as application-layer data communicated to and from served UEs. In example implementations, the subscriber profile store 216 may hold a subscriber profile record respectively for each service subscription with the MNO, keyed to the associated subscriber identifier and/or UE hardware identifier and containing associated network access credentials and other data.

Each access node may broadcast in its coverage area a reference signal that UEs could measure as a basis to detect the presence and strength of coverage. When the UE 100 initially powers on in or otherwise enters into coverage of one of the illustrated access nodes 200, the UE may make use of the PRL in its active operational eSIM profile to scan for applicable coverage and may thereby discover threshold strong coverage from the access node 200. The UE may then responsively engage in random access signaling and Radio Resource Control (RRC) signaling to establish an RRC connection (i.e., a radio link layer connection) between the UE and the access node 200. Further, with this RRC connection established, the UE may then engage in an attachment process to register to be served by the MNO.

In an example attachment process, the UE may generate and transmit via its RRC connection (and thus via the access node 200) to the network controller 212 an attach request. In this attach request, the UE may provide its subscriber identifier, such as the IMSI of the UE's active operational eSIM profile (e.g., the UE's primary active operational eSIM profile). The network controller 212 may then interact with the authentication center 214 to trigger a process of authenticating the UE for service, keyed to the UE's subscriber identifier. For instance, the authentication center may use the provided subscriber identifier as a basis to look up an associated record in the subscriber profile store 216 and may then engage in authentication signaling with the UE, making use of network access credentials, such to confirm that the UE and authentication center would compute a matching authentication result for instance.

Upon successful authentication of the UE, the network controller 212 may record in the subscriber profile store 216 a record of where the UE is being served, such as what access node or associated location/tracking area of the MNO's network is serving the UE, to enable paging and other messaging to the UE. Further, the network controller 212 may assign to the UE a temporary subscriber identifier, such as a Globally Unique Temporary UE Identity (GUTI), which the network controller may provide to the UE and may map in the subscriber profile store 216 to the UE's actual subscriber identifier. Assignment of this temporary subscriber identifier may enable the UE to later connect with the MNO's network without needing to send its actual subscriber identifier over the air—as the network controller would have a mapping of the temporary subscriber identifier to the UE's actual subscriber identifier and could therefore trigger associated authentication and other processing.

In some implementations, the attachment and/or authentication process may also make use of the UE's hardware identifier. For instance, when the UE sends an attach request to the network controller 212, or in response to a further request from the network controller, the UE may provide the network controller with the UE's hardware identifier, such as an MEID or IMEI. The authentication center may then use the provided hardware identifier as a basis to look up an associated record in the subscriber profile store 216 and may then engage in an authentication process as noted above. Further, upon successful authentication, the network controller 212 may similarly record in the subscriber profile store 216 a record of where the UE is being served.

Once the UE is authenticated for service, the network controller 212 may then engage in control signaling with the user-plane subsystem 210 to establish for the UE a user-plane bearer for carrying user-plane data between the UE and the transport network 206. Then with this bearer established, the MNO may serve the UE in accordance with the UE's service subscription. For instance, when the UE has data to transmit on the transport network 206, the UE may engage in control signaling with its serving access node 200 to have the access node schedule uplink transmission of the data, the UE may accordingly transmit the data as scheduled to the access node, and the access node may forward the data along the UE's established bearer for output onto the transport network. Likewise, when data arrives from the transport network for delivery to the UE, the data may flow on the UE's bearer to the UE's serving access node, and the access node may then schedule and engage in downlink transmission of the data to the UE.

Further, while the UE is served by an access node, the UE may regularly measure the strength of coverage from the access node and the strength of coverage from neighboring access nodes, and if one or more measurement conditions are met, the UE and/or its serving access node may trigger handover of the UE from the serving access node to a neighboring access node. As part of this handover process, signaling may also pass to the network controller 212, and the network controller may responsively update the record of where the UE is being served in the MNO's network, such as to indicate the coverage area or tracking/location area where the UE is operating.

As further shown in FIG. 2, the control-plane subsystem of the MNO's network may also include a mobile location system (MLS) 220. The MLS 220 may operate to determine, store, and report the geolocation of the UE when authorized. For instance, the MLS 220 may interwork with the location-determining module 106 of UE 100 to determine the geolocation of the UE, based on GNSS signals received by the UE. Further, the MLS 220 may store the determined geolocation in association with the UE's subscriber identifier and/or hardware identifier, and the MLS 220 may report its determined location if authorized to various location-based service providers such as navigation services or the like.

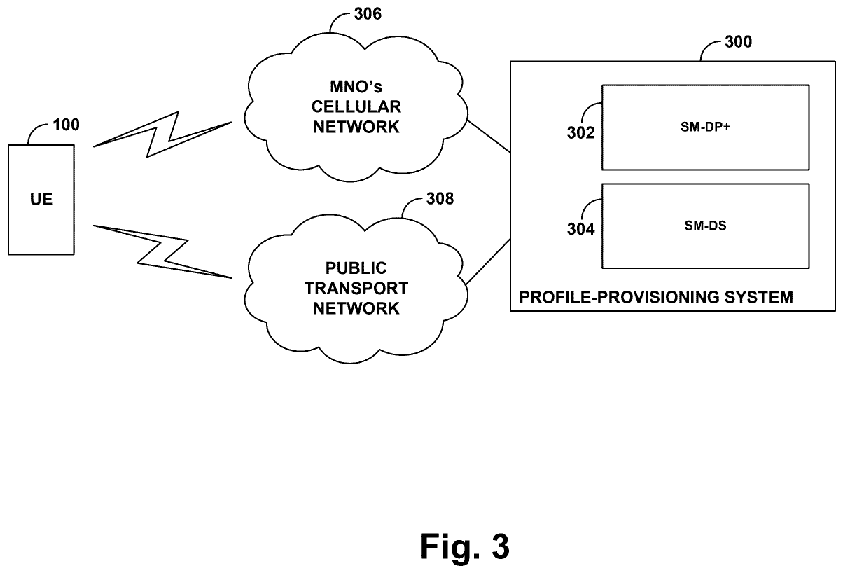

FIG. 3 is a simplified block diagram illustrating a network arrangement through which an MNO could provision an operational eSIM profile into the eSIM 112 of UE 100. The arrangement shown includes a profile-provisioning system 300, which includes a subscription manager data preparation (SM-DP+) system 302 and a subscription manager discovery service (SM-DS) 304. This example profile-provisioning system 300 is shown interconnected with the MNO's cellular network 306 and also accessible through a public transport network 308 such as the internet. With this arrangement, the profile-provisioning system 300 could interact with the MNO's core network, such as to load subscription profiles into the subscription profile store noted above. Further, the UE 100 may be able to communicate with the profile-provisioning system 300 either through WiFi connectivity or through an MNO connection that the UE establishes using a non-operational eSIM profile.

With this example arrangement, the SM-DP+ could handle creation and installation of operational eSIM profiles, and the SM-DS may enable LPAs to discover and download such profiles. For instance, when a user subscribes with the MNO for the MNO to serve the example UE 100, the MNO may work with the SM-DP+ to generate for the UE an operational eSIM profile specific to that service subscription and may work with the SM-DS to inform the UE's LPA of the availability of that operational eSIM profile to download. Further, the MNO may store associated service profile data, including the associated subscriber identifier and perhaps the associated UE hardware identifier, in its subscriber profile store. The UE's LPA may then engage in signaling with the SM-DP+ to download and store in the UE's eSIM the operational eSIM profile, with a secure exchange between the LPA and the SM-DP+ normally conveying the UE's EID to the SM-DP+ and the SM-DP+ maintaining a mapping between the assigned profile (or associated IMSI) and that EID. In addition, the LPA may activate the downloaded operational eSIM profile and may signal to the SM-DP+ to indicate that the operational eSIM profile is active, and the MNO may record in the subscription profile store an indication of the active status of the operation. Other profile provisioning processes are possible as well.

As noted above, the present disclosure provides for facilitating temporary incognito service. In particular, the UE may regularly operate in a default mode with one or more default identifiers, and the UE may temporarily transition to operate in an incognito mode with one or more incognito identifiers and then, after passage of a time period, automatically revert to operate again in the default mode with the one or more default identifiers.

In an example of this process, the UE may transition to operate with an incognito operational eSIM profile in place of the UE's default operational eSIM profile and then, after a period of time, automatically revert to operate again with the default operational eSIM profile in place of the incognito operational eSIM profile. Alternatively or additionally, the UE may transition to operate with an incognito hardware identifier in place of the UE's permanent hardware identifier and then, after a period of time, automatically revert to operate again with the permanent hardware identifier in place of the incognito hardware identifier. Still further, if the UE has a default phone number, the UE may transition to operate with an incognito phone number in place of the default phone number and then, after a period of time, automatically revert to operate again with the default phone number in place of the incognito telephone number.

Having the UE operate temporarily with one or more incognito identifiers in place of the UE's one or more default identifiers may help to preserve privacy of the user of the UE. For instance, this process may help avoid correlating the UE's location (e.g., network location or geolocation) with the UE's actual default identifiers, which may help keep secret the user's presence at particular locations. Further, having the UE operate temporarily with one or more incognito identifiers in place of the UE's one or more default identifiers may help to avoid bogging down data storage over time with data regarding any one given identifier.

In an example implementation, this incognito service could be provided or facilitated by an incognito service provider. The incognito service provider may be the same MNO with which the UE has an established service subscription and for which the UE normally operates under an associated default operational eSIM profile. Alternatively, the incognito service provider could be another MNO or other entity, perhaps an MVNO, that could supply the UE with an incognito eSIM profile for temporary use by the UE and/or an incognito UE hardware identifier and/or incognito phone number for use by the UE.

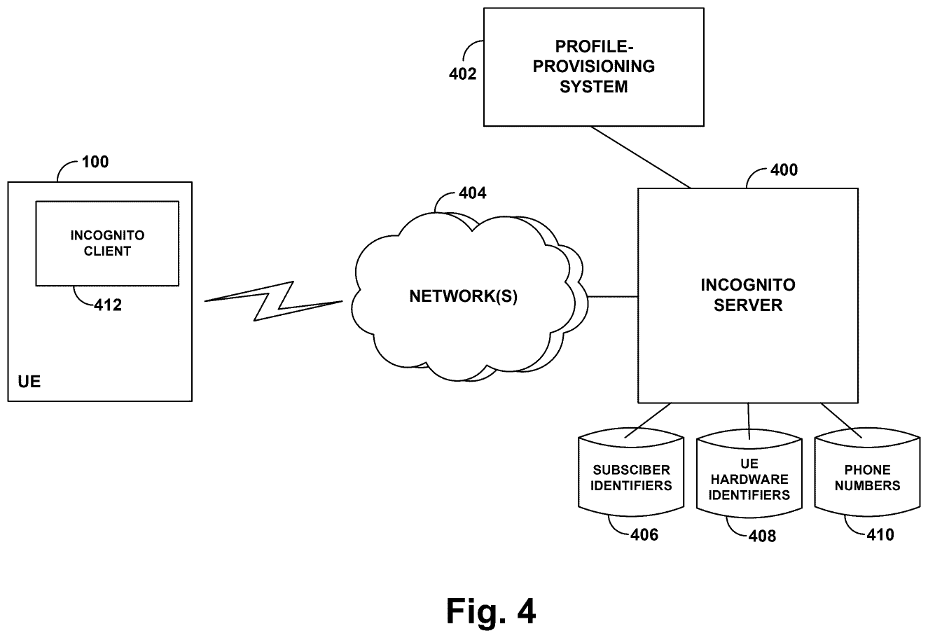

FIG. 4 is a simplified block diagram depicting an example network arrangement for carrying out an example of this process. Namely, FIG. 4 shows the UE 100 being arranged to communicate with an incognito server 400 (or more generally a cloud-based computing system, perhaps a secure enclave server or confidential computing system) and with a profile-provisioning system 402. In particular, the figure shows the UE having wireless connectivity with one or more networks 404 that provide connectivity to enable the UE to communicate with the incognito server 400 and with the profile-provisioning system 402. The one or more networks 404 may include a wireless communication network (e.g., one or more access nodes and a core network) provided by the MNO to which the UE subscribes and for which the UE operates under an associated default operational eSIM profile. Alternatively or additionally, the one or more networks 404 may include WiFi access points, local area networks, and the public internet, among other possibilities.

In example arrangement, the profile-provisioning system 402 is a profile-provisioning system of an MNO (e.g., of an MVNO), and the profile-provisioning system 402 could be structured as discussed above, including an SM-DP+ and an SM-DS to facilitate creation and installation of operational eSIM profiles on UEs. However, to help further protect user privacy, the SM-DP+ in a preferred implementation could be configured to not maintain a mapping between the UE's EID and an incognito profile (and/or one or more particular incognito identifiers) assigned to the UE. Further, as shown, the incognito server 400 in the example arrangement is in communication with the profile-provisioning system 402, which may enable the incognito server 400 to interwork with the profile-provisioning system 402 to trigger creation and installation of incognito eSIM operational profiles on UEs.

As further shown, the incognito server 400 includes or has access to various sets of identifiers that can be assigned to serve as incognito identifiers according to the present disclosure. In the example arrangement, this includes a set of subscriber identifiers 406, a set of UE hardware identifiers 408, and a set of phone numbers 410. Each of these sets of identifiers may be authorized by a respective authorizing entity and may take the forms discussed above, among other possibilities. For instance, the set of subscriber identifiers 406 may be a set of unique IMSIs authorized by a standards body responsible for authorizing IMSIs, the set of UE hardware identifiers 408 may be a set of unique MEIDs authorized by a standards body responsible for authorizing MEIDs, and the set of phone numbers 410 may be a set of unique MSISDNs authorized by a standards body responsible for authorizing phone numbers. In a scenario where certain identifiers are on blocked-identifier lists (such as MEIDs on a global blocked-MEID list), the sets of authorized identifiers could exclude any such blocked identifiers, to help avoid assigning for incognito use a blocked identifier.

The incognito server 400 could be operated by an MNO (e.g., an MVNO), which could enable the incognito server to obtain at least the subscriber identifiers (e.g., IMSIs) and phone numbers (e.g., MSISDNs) just as an MNO would normally obtain such identifiers for assignment to its subscribers. Further, the incognito server 400 may obtain the hardware identifiers (e.g., MEIDs) just like a UE-manufacturing factory would normally obtain such identifiers for assignment to UEs that it manufactures. Each of these sets of identifiers may include on the order of hundreds or thousands of such identifiers. Further, the incognito server 400 may be provisioned in advanced with each of these sets of identifiers (or with specifics such sets), or the incognito server 400 may obtain various such identifiers dynamically on an as-needed basis, such as by requesting and obtaining the identifiers from issuing bodies when desired.

In an example implementation, the UE 100 could further include an incognito client application 412 that may facilitate interworking with the incognito server 400 and with the UE's LPA, among other possibilities, to manage the UE's transition to incognito mode and the UE's automatic reversion to its default operational mode. For instance, the incognito client 412 may engage in signaling with the incognito server 400 to facilitate provisioning the UE with an incognito operational eSIM profile and/or an incognito UE hardware identifier and indicating when that incognito data is in use and when it can be released for others use. Further, the incognito client 412 may engage in signaling with the UE's LPA to install and activate the incognito operational eSIM profile for use and to then automatically revert to a default operational eSIM profile after a period of time, and the incognito client 412 may operate to register in the UE the incognito UE hardware identifier for use and to then automatically revert to the UE's permanent hardware identifier after a period of time.

The incognito client 412 may further facilitate an anti-abuse service to, for example, prevent abuse of incognito mode to avoid service charges, such as charges for data service.

To facilitate transitioning from the UE's default operational mode (e.g., with the operational eSIM profile associated with the UE's normal service subscription) to incognito mode, the incognito client 412 could transmit to the incognito server 400 an incognito_request message. In response to this incognito_request message, the incognito server 400 could then randomly select and provision the UE 100 with one or more identifiers for temporary, incognito use.

By way of example, in response to this incognito_request message, the incognito server 400 could randomly select from the set of subscriber identifiers 406 a subscriber identifier for temporary use by the UE 100, and the incognito server 400 could interwork with the profile-provisioning system 402 to have the profile-provisioning system 402 establish an operational eSIM profile with the selected subscriber identifier and populate a corresponding service profile in an associated MNO subscriber profile store to facilitate authentication and service of the UE operating with this operational eSIM profile. In addition or alternatively, the incognito server 400 may randomly select from the set of phone numbers 408 a phone number for temporary use by the UE 100, and the incognito server 400 could have the profile-provisioning system include the selected phone number into the operational eSIM profile. The incognito server 400 may also flag each such selected identifier as currently in use (or, e.g., remove them from the sets of identifiers) to help avoid double-assigning the same identifier to more than one UE at once.

Further, the incognito server 400 may respond to the incognito client 412 with information that enables and causes the UE's LPA to download from the profile-provisioning system 402 the newly established operational eSIM profile. For instance, the incognito server 400 may provide the incognito client 412 with a universal resource locator (URL) or other address from which to obtain the new operational eSIM profile from the profile-provisioning system 402, and the incognito client 412 may responsively direct the UE's LPA to accordingly obtain the operational eSIM profile. Thus, the UE's LPA may download the operational eSIM profile having a subscriber identifier that the incognito server 400 randomly selected from the set of subscriber identifiers 406 and/or having a phone number that the incognito server 400 randomly selected from the set of phone numbers 410, and the LPA may store the downloaded operational eSIM profile on the UE's eSIM.

To enter into incognito mode with respect to this downloaded and installed operational eSIM profile, the incognito client 412 may direct and thus cause the UE to detach from any MNO network with which the UE is currently attached, and may then direct and thus cause the UE's LPA to deactivate the UE's currently active (e.g., primary) operational eSIM profile and activate in its place the new operational eSIM profile as an incognito operational eSIM profile. The UE could then operate in incognito mode at least in part by operating with this incognito operational eSIM profile rather than with its default operational eSIM profile. For instance, the UE may then newly scan for coverage in line with a PRL in the newly active incognito operational eSIM profile and, upon finding threshold strong coverage may engage in random access signaling, RRC signaling, and attachment including authentication keyed to the subscriber identifier in the incognito operational eSIM profile. Further, if applicable, the UE may engage in telephony service using the phone number in the incognito operational eSIM profile.

In an alternative implementation, if the UE has multiple active operational eSIM profiles, the incognito client 412 may direct and thus cause the UE to change the UE's current primary operational eSIM profile to be a secondary operational eSIM profile and to activate and set the new incognito operational eSIM profile as the UE's primary operational eSIM profile.

After a period of time of operating in the incognito mode, the incognito client 412 may then automatically revert the UE from the incognito mode to the UE's default operational mode. For instance, the incognito client 412 may direct and thus cause the UE to detach from any MNO network with which the UE is currently attached, and may then direct and thus cause the UE's LPA to deactivate the incognito operational eSIM profile (including possibly deleting the incognito operational eSIM profile from the eSIM) and to reactivate (or change to primary) in its place the UE's default operational eSIM profile, i.e., the operational eSIM profile that the incognito operational eSIM profile replaced. The UE could then once again operate in its default mode at least in part by operating with its default operational eSIM profile rather than with the incognito operational eSIM profile. For instance, the UE may then newly scan for coverage in line with a PRL in its default operational eSIM profile and, upon finding threshold strong coverage may engage in random access signaling, RRC signaling, and attachment including authentication keyed to the subscriber identifier in its default operational eSIM profile. Further, if applicable, the UE may engage in telephony service using the phone number in its default operational eSIM profile.

In addition, the incognito client 412 could inform the incognito server 400 and/or the profile-provisioning system 402 when the UE stops using the incognito operational eSIM profile. When the UE stops using the incognito operational eSIM profile, the incognito server 400 may release the subscriber identifier and/or phone number that had been temporarily assigned to the UE, to make each such identifier newly available in the pool of identifiers, for random selection and assignment. The profile-provisioning system 402 may also update its records and the MNO subscriber profile records, such as by removing the service profile data associated with the temporarily assigned incognito operational eSIM profile.

Further, in addition to or instead of having the UE operate with an incognito operational eSIM profile, the present process may involve having the UE operate with an incognito UE hardware identifier. For instance, in addition or alternatively in response to the incognito_request from the incognito client 412, the incognito server 400 could randomly select from the set of UE hardware identifiers 408 a UE hardware identifier for temporary use by the UE, and the incognito server 400 could return that UE hardware identifier in a response to the UE and flag the hardware identifier as currently in use (or remove it from the set of hardware identifiers) to help avoid double assignment. The incognito client 412 may then store this received UE hardware identifier for use. Further, the incognito server 400 may interwork with the profile-provisioning system 402 and/or with the associated MNO to record the hardware identifier as a hardware identifier of the UE.

To enter into incognito mode with respect to this received UE hardware identifier, possibly as part of entering into the incognito mode as discussed above, the incognito client 412 may register the received hardware identifier for its use as an incognito hardware identifier in place of the UE's permanent hardware identifier. For instance, the incognito client 412 may call an operating system API to set a flag that designates and causes this incognito hardware identifier to be used in place of the UE's permanent hardware identifier. The UE could then operate in incognito mode at least in part by operating with this incognito hardware identifier rather than the UE's permanent hardware identifier. For instance, if the UE would provide its hardware identifier as part of the attachment process and/or authentication process, the UE may provide its incognito hardware identifier instead. Further, if another action would be taken with respect to the UE's hardware identifier, the incognito hardware identifier may be used instead.

After a period of time of operating in this incognito mode, the incognito client's automatic reversion of the UE from the incognito mode to the UE's default operational mode may then include the incognito client 412 de-registering the incognito hardware identifier from the UE, such as by calling an operating system API to clear the flag that designated and cause the incognito hardware identifier to be used in place of the UE's permanent hardware identifier. The UE would thus revert to using its permanent hardware identifier in place of the incognito hardware identifier for associated operations.

Note also that variations on the above process are possible as well. Without limitation, for instance, an alternative approach could be to provision the UE with a skeleton eSIM operational profile, having one or more placeholders that could be filled in with one or more temporarily assigned incognito identifiers, and to then dynamically fill in that skeleton profile with one or more such incognito identifiers. Such a skeleton profile, for instance, might include an IMSI placeholder that could be filled in with a temporarily assigned incognito IMSI, and perhaps an MSISDI placeholder that could be filled in with a temporarily assigned incognito MSISD, among other possibilities.

In an example implementation of this alternative approach, rather than using a typical eSIM provisioning process, an incognito server or other entity might use its own provisioning process, possibly through interaction with the incognito client 412, to securely load such a skeleton eSIM operational profile into the UE's eSIM. This or other initial provisioning of the skeleton profile into the UE's eSIM could be done at various times, such as upon UE manufacture, at the time the incognito client is initially installed on the UE, or the first time the UE first going to transition to the incognito mode, among other possibilities. In addition, to further protect user privacy, the incognito server or other entity that carries out this process may avoid recording a mapping between the UE's EID and this skeleton profile.

To make use of this skeleton profile, in order to transition the UE to incognito mode, the incognito server may operate as described above to randomly provision one or more incognito identifiers for temporary use by the UE. However, rather than then provisioning the UE with an incognito operational eSIM profile, the incognito server could provide the UE's incognito client with the selected incognito identifier(s), and the incognito client could insert the provided incognito identifier(s) into the appropriate place(s) of the UE's skeleton operational eSIM profile. For instance, the incognito server could provide the UE with a randomly selected IMSI, and the incognito client, possibly working with the UE's LPA, could dynamically insert that IMSI into the UE's skeleton profile in place of an IMSI placeholder, to establish an incognito eSIM operational profile for the UE, which could be activated in place of the UE's current active and/or primary eSIM operational profile as discussed above. In turn, the act of reverting from incognito mode to the UE's default mode, could then involve switching back to the UE's default operational eSIM profile and clearing from the skeleton profile any temporarily assigned identifiers, so that the skeleton profile can then be used again later with one or more newly assigned incognito identifiers.

Further, the UE may be provisioned with more than one incognito identifier, and the UE may randomly rotate between them.

There could be various triggers for the UE transitioning from its default operational mode to the incognito mode, or vice versa. Without limitation, three example triggers are (i) location, (ii) time, and (iii) manual user input. In an example implementation, the incognito client 412 may provide settings dialog that the UE could present on a display screen of its user interface 104, and through this settings dialog, the incognito client may allow a user to designate when the incognito client should monitor for a trigger for entering (or exiting) incognito mode, and/or through which a user may manually direct the incognito client to put the UE into (or out of) the incognito mode.

As to location, the incognito client 412 may detect (e.g., learn) when the UE's current location satisfies a predefined location condition, such as that the UE's location is within a geographic area where it may be desirable to have the UE operate in the incognito mode. The incognito client 412 may make this determination through interaction with the location-determining module 106 of the UE, which may further interact with the MLS 220 of the UE's serving MNO, among other possibilities. Further, the incognito client 412 may be provisioned with data defining a “geofence” area where the incognito mode should or should not be used, perhaps by user configuration in the settings dialog of the incognito client 412. The incognito client 412 may thus monitor and compare the UE's location with the geofence and, when the UE's location falls within (or outside) the geofence, may transition the UE to (or out of) the incognito mode.

Use of location as a trigger for entering the incognito mode may facilitate having the UE operate in the incognito mode when the UE is located at a sensitive location, such as at a doctor's office or other such facility, where it may be desirable to not correlate the UE's location with the user.

As to time, the incognito client 412 may detect (e.g., learn) when the current time (e.g. time of day, day of week, etc.) satisfies a predefined time condition, such as that the current time is within a time range where it may be desirable to have the UE operate in the incognito mode. The incognito client 412 may make this determination by monitoring a time clock. Further, the incognito client 412 may be provisioned with data defining a time range when the incognito mode should (or should not) be used or time when the incognito mode should start (or end), perhaps per a user's schedule on a calendar stored in the UE, and/or likewise perhaps by user configuration in the settings dialog of the incognito client 412. The incognito client 412 may thus monitor and compare the current time with the defined time range or start time, and when a time condition is met may then responsively transition the UE to (or out of) the incognito mode.

Use of time as a trigger for entering the incognito mode may facilitate having the UE operate in the incognito mode at a time when the UE is located at a sensitive location, such as may be indicated by calendar data in the UE.

As further noted above, the UE may automatically revert from the incognito mode to its default operational mode after a passage of time, such as a period of 24 hours of operating in the incognito mode or passage of another time period.

The incognito client 412 may control this automatic reversion by setting a timer when the incognito client 412 transitions the UE to the incognito mode and then responding to expiration of the timer by automatically reverting the UE from the incognito mode to the default mode. The duration of this timer may be set by default to a duration and/or may be set by user input through the settings dialog of the incognito client 412. Thus, the incognito client 412 may detect expiration of such a timer, reflecting the UE having operated in the incognito mode for a period of time corresponding with the timer duration, and the incognito client 412 may then responsively revert the UE from the incognito mode to the default mode.

Alternatively or additionally, as noted above, there may be one or more other criteria for the incognito client 412 to determine when it should automatically revert the UE from the incognito mode to the default mode. For instance, perhaps in an implementation where location of the UE was a trigger for transitioning the UE to the incognito mode, the incognito client 412 may use location of the UE as a further trigger for automatically reverting the UE back to its default operational mode. By way of example, if the incognito client 412 transitioned the UE to the incognito mode in response to detecting that the UE's location was within a predefined geofence, the incognito client 412 may then automatically revert the UE to the default mode in response to thereafter detecting that the UE's location is no longer within that geofence.

In an example implementation, the incognito client 412 may have earlier obtained the incognito data that would facilitate the UE operating in the incognito mode, in which case the act of transitioning the UE to the incognito mode could involve activating that incognito data in place of default data. Further, once the UE reverts from the incognito mode to its default mode, the incognito client 412 may then obtain new incognito data to have available to activate the next time a trigger is detected for the UE to transition to the incognito mode.

For instance, the incognito client 412 may have earlier caused the UE to obtain an incognito operational eSIM profile, and the incognito client 412 may then transition the UE to the incognito mode by causing the UE's LPA to deactivate the UE's default operational eSIM profile and to activate the incognito operational eSIM profile. Once the incognito client 412 then reverts the UE from using the incognito operational eSIM profile to using its default operational eSIM profile by deactivating the incognito operational eSIM profile and reactivating the UE's default operational eSIM profile, the incognito client 412 may then work to obtain a new incognito operational eSIM profile that the incognito client 412 could cause the LPA to likewise activate in place of the UE's default operational eSIM profile the next time the incognito client 412 detects a trigger for doing so.

Likewise, the incognito client 412 may have earlier obtained an incognito UE hardware identifier, and the incognito client 412 may then transition the UE to the incognito mode by registering that hardware identifier to be used by the UE in place of the UE's permanent hardware identifier. Once the incognito client 12 then reverts the UE from using the incognito hardware identifier to using its permanent hardware identifier, the incognito client 412 may then work to obtain a new incognito hardware identifier that the incognito client 412 could cause the UE to use in place of the UE's permanent hardware identifier the next time the incognito client 412 detects a trigger for doing so.

Alternatively, the incognito client 412 may dynamically obtain such incognito data on the fly, when the data is to be used. For instance, when the incognito client 412 detects a location trigger and/or time trigger, or receives a manual user request trigger, for transitioning the UE to the incognito mode, the incognito client 412 may then responsively transmit to the incognito server 400 an incognito_request and may proceed as discussed above to cause the UE to transition to the incognito mode. Thus, in response to detecting a trigger for transition to the incognito mode, the incognito client 412 might cause the UE to be provisioned with a new incognito operational eSIM profile and cause that incognito operational eSIM profile to be activated in place of the UE's default operational eSIM profile. Further, in response to detecting a trigger for the UE to transition to the incognito mode, the incognito client might obtain an incognito hardware identifier and register that incognito hardware identifier for use in place of the UE's permanent hardware identifier.

Note also that the act of detecting triggers for transition to the incognito mode and/or for automatically reverting to the default mode may be coordinated and/or carried out in part by the incognito server 400 and/or one or more other entities. For instance, the incognito server 400 may detect a location and/or time trigger as noted above and may responsively signal to the incognito client 412 to trigger transition to the incognito mode.

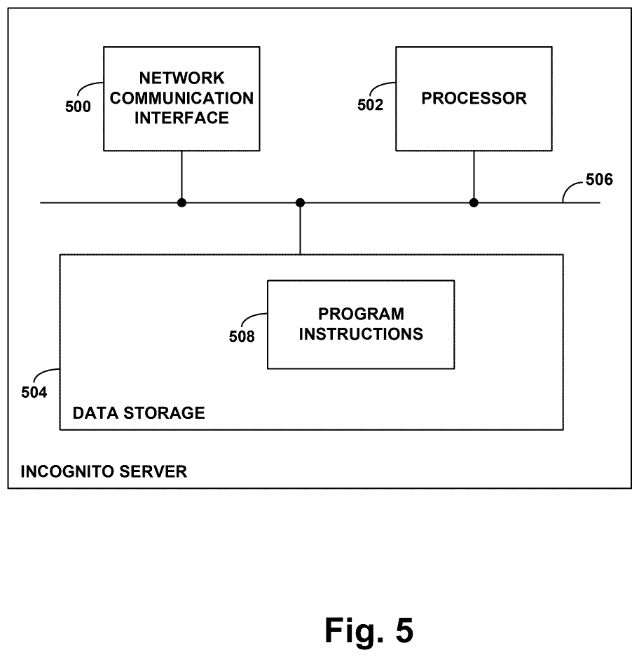

FIG. 5 is a simplified block diagram of an example incognito server that could operate in the arrangement of FIG. 4 for example. As shown, the example incognito server includes a network communication interface 500, a processor 502, and non-transitory data storage 504, all of which may be communicatively linked together by a system bus or other connection mechanism 506.

The network communication interface 500 could comprise any communication module facilitating communication with other entities like those shown in FIG. 4. The processor 502 could comprise one or more general purpose processors (e.g., microprocessors) and/or one or more special purpose processors (e.g., application specific integrated circuits). The non-transitory data storage 504 could then comprise one or more volatile and/or non-volatile storage components. As shown, the non-transitory data storage 504 could hold program instructions 508, which could be executable by the processor 502 to carry out various incognito-server operations. Thus, the incognito server could be configured to carry out various such operations by being programmed with instructions executable by the processor 502 to carry out those operations, among other possibilities.

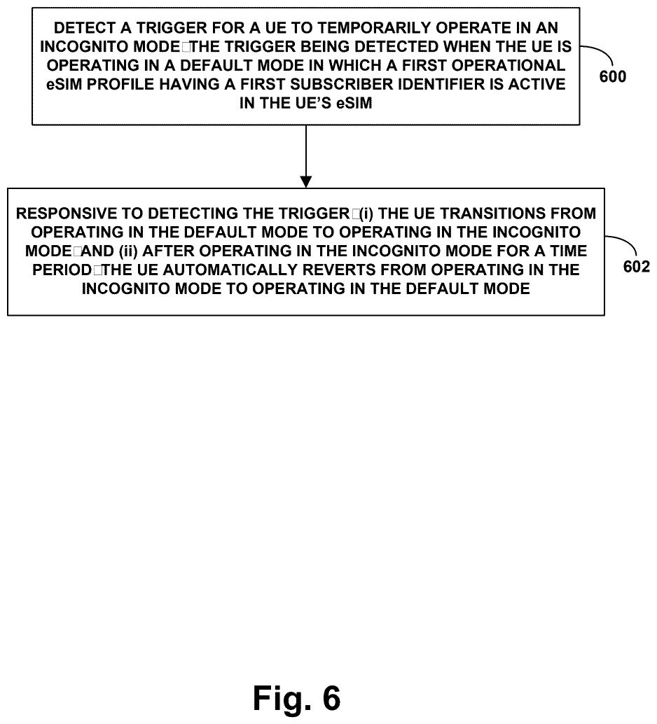

FIG. 6 is next a flow chart depicting an example method that could be carried out in accordance with the present disclosure to have a UE temporarily operate in an incognito mode and then automatically revert to operating in its default mode.

As shown in FIG. 6, at block 600, the method could involve detecting a trigger for a UE to temporarily operate in an incognito mode, the trigger being detected when the UE is operating in a default mode in which a first operational eSIM profile having a first subscriber identifier is active in the UE's eSIM. Further, at block 602, the method could involve, responsive to detecting the trigger, (i) the UE transitioning from operating in the default mode to operating in the incognito mode, and (ii) after operating in the incognito mode for a time period, the UE automatically reverting from operating in the incognito mode to operating in the default mode.

The act of transitioning the UE from operating in the default mode to operating in the incognito mode could involve (a) deactivating the first operational eSIM profile in the eSIM and activating in the eSIM a second operational eSIM profile in place of the first operational eSIM profile, the second operational eSIM profile having a second subscriber identifier different than the first subscriber identifier and having not been previously active in the eSIM, and (b) per the second operational eSIM profile, using the second subscriber identifier to facilitate engaging in wireless communication service.

Further, the act of automatically reverting the UE from operating in the incognito mode to operating in the default mode could involve (a) deactivating the second operational eSIM profile in the eSIM and reactivating in the eSIM the first operational eSIM profile in place of the second operational eSIM profile, and (b) per the first operational eSIM profile, using the first subscriber identifier to facilitate engaging in wireless communication service.

In addition, the act of automatically reverting from operating in the incognito mode to operating in the default mode after operating in the incognito mode for a time period could involve detecting passage of the time period of the UE operating in the incognito mode and, responsive to detecting passage of the time period of the UE operating in the incognito mode, automatically reverting from operating in the incognito mode to operating in the default mode.

Further, the method could also include transmitting from the UE to a cloud-based computing system (e.g., an incognito server) a request for assignment to the UE of an incognito profile, and the cloud-based computing system could be configured to respond to the request by assigning to the UE the second subscriber identifier and triggering establishment of the second operational eSIM profile for download to the UE. In that case, the act of automatically reverting from the incognito mode to the default mode may also include transmitting from the UE to the cloud-based computing system a message indicating that the UE is finished with use of the second subscriber identifier, and the cloud-based computing system could be configured to respond to the message by releasing the second subscriber identifier for assignment to another UE.

In addition, the UE may have a permanent hardware identifier that the UE uses in the default mode to facilitate engaging in wireless communication service. In that case, the method may also involve, in the incognito mode, using a temporary hardware identifier in place of the permanent hardware identifier to facilitate engaging in wireless communication service. Further, the act of automatically reverting from the incognito mode to the default mode could also include reverting to use the permanent hardware identifier to facilitate engaging in wireless communication service.

Further, the method could additionally involve transmitting from the UE to a cloud-based computing system a request for assignment to the UE of an incognito hardware identifier, and the cloud-based computing system could be configured to respond to the request by assigning to the UE the temporary hardware identifier for use by the UE in place of the permanent hardware identifier. Yet further, the act of automatically reverting from the incognito mode to the default mode could additionally include transmitting from the UE to the cloud-based computing system a message indicating that the UE is finished with use of the temporary hardware identifier, and the cloud-based computing system could be configured to respond to the message by releasing the temporary hardware identifier for assignment to another UE.

Still further, the first operational eSIM profile in the method could be an operational eSIM profile for service from a first mobile network operator, and the second operational eSIM profile could be an operational eSIM profile for service from a second mobile network operator different than the first mobile network operator. Alternatively, the second operational eSIM profile could be another operational eSIM profile for service from the first mobile network operator.

Further, the act of detecting the trigger for the UE to temporarily operate in the incognito mode could involve detecting that a current geolocation of the UE satisfies a predefined location condition. Yet further, the act of automatically reverting from operating in the incognito mode to operating in the default mode after operating in the incognito mode for a time period could involve (i) detecting that a current geolocation of the UE no longer satisfies the predefined location condition and (ii) responsive to detecting that the current geolocation of the UE no longer satisfies the predefined location condition, automatically reverting from operating in the incognito mode to operating in the default mode.

Alternatively or additionally, the act of detecting the trigger for the UE to temporarily operate in the incognito mode could involve detecting that a current time satisfies a predefined time condition. Still alternatively, the act of detecting of the trigger for the UE to temporarily operate in the incognito mode comprises detecting receipt into the UE of user input (e.g., entry into an incognito-client settings dialog or other user interface) defining a request for the UE to temporarily operate in the incognito mode.

In addition, the method could involve pre-storing in the eSIM the second operational eSIM profile in anticipation of the detecting of the trigger, in which case the act of activating the second operational eSIM profile could involve activating the pre-stored second operational eSIM profile. Alternatively, the act of the UE transitioning to operating in the incognito mode could involve (i) the UE downloading the second operational eSIM profile and (ii) storing in the eSIM the downloaded second operational eSIM profile, in which case the act of activating the second operational eSIM profile could involve activating the downloaded second operational eSIM profile.

Further, the first operational eSIM profile could have a first phone number that the UE is configured to use in the default mode to facilitate engaging in telephony service, and the second operational eSIM profile may also have a second phone number that is different than the first phone number and that the UE is configured to use in the incognito mode to facilitate engaging in telephony service.

Note also that various operations described herein as being carried out with respect to eSIM technology could alternatively be carried out with respect to other forms of subscriber identifier technology.

Further, while the above discussion provides for temporarily assigning one or more incognito identifiers to a UE for a period of time and then automatically reverting to the UE's default identifier(s) after that period of time, an alternative implementation could involve changing one or more such assigned incognito identifiers during the period of time. For instance, if the UE will operate in incognito mode for nine minutes, (i) the system could randomly select and assign to the UE a first incognito IMSI for the UE to use instead of its default IMSI at the start of the nine minute period, (ii) the system could then select and randomly assign to the UE a second, different incognito IMSI for the UE to use instead of the first incognito IMSI starting at the three-minute point into the nine-minute period, and (iii) the system could then select and randomly assign to the UE a third, different incognito IMSI for the UE to use in place of the second incognito IMSI starting at the six-minute point into the nine-minute period. Upon expiration of the nine-minute period, the system could then cause the UE to revert to use the UE's default IMSI. Other examples could be possible as well.

As further discussed above, the present disclosure also contemplates a UE having a processor, non-transitory data storage, an eSIM, a transceiver, and an antenna structure supporting air-interface communication, with the non-transitory data storage holding program instructions executable by the processor to cause the UE to carry out operations such as those discussed above. In addition, the present disclosure contemplates a non-transitory computer-readable medium having stored thereon instructions executable by a processor to cause a UE to carry out such operations.

Example embodiments have been described above. Those skilled in the art will understand, however, that changes and modifications may be made to these embodiments without departing from the true scope and spirit of the invention.

1. A method comprising:
detecting a trigger for a user equipment device (UE) to temporarily operate in an incognito mode, wherein the UE has an embedded subscriber interface module (eSIM), and wherein, when the trigger is detected, the UE is operating in a default mode in which a first operational eSIM profile having a first subscriber identifier is active in the eSIM; and
responsive to detecting the trigger, (i) transitioning by the UE from operating in the default mode to operating in the incognito mode, and (ii) after operating in the incognito mode for a time period, automatically reverting by the UE from operating in the incognito mode to operating in the default mode,
wherein the transitioning comprises (a) deactivating the first operational eSIM profile in the eSIM and activating in the eSIM a second operational eSIM profile in place of the first operational eSIM profile, wherein the second operational eSIM profile has a second subscriber identifier different than the first subscriber identifier and has not been previously active in the eSIM, and (b) per the second operational eSIM profile, using the second subscriber identifier to facilitate engaging in wireless communication service, and
wherein the automatically reverting comprises (a) deactivating the second operational eSIM profile in the eSIM and reactivating in the eSIM the first operational eSIM profile in place of the second operational eSIM profile, and (b) per the first operational eSIM profile, using the first subscriber identifier to facilitate engaging in wireless communication service.

2. The method of claim 1, wherein the automatically reverting from operating in the incognito mode to operating in the default mode after operating in the incognito mode for a time period comprises:
detecting a passage of the time period of the UE operating in the incognito mode; and
responsive to detecting the passage of the time period of the UE operating in the incognito mode, automatically reverting from operating in the incognito mode to operating in the default mode.

3. The method of claim 1, further comprising transmitting from the UE to a cloud-based computing system a request for assignment to the UE of an incognito profile, wherein the cloud-based computing system is configured to respond to the request by assigning to the UE the second subscriber identifier and triggering establishment of the second operational eSIM profile for download to the UE,
wherein the automatically reverting from the incognito mode to the default mode further comprises transmitting from the UE to the cloud-based computing system a message indicating that the UE is finished with use of the second subscriber identifier, wherein the cloud-based computing system is configured to respond to the message by releasing the second subscriber identifier for assignment to another UE.

4. The method of claim 1, wherein the UE has a permanent hardware identifier of the UE that the UE uses in the default mode to facilitate engaging in wireless communication service, the method further comprising:
in the incognito mode, using a temporary hardware identifier in place of the permanent hardware identifier to facilitate engaging in wireless communication service,
wherein the automatically reverting from the incognito mode to the default mode further comprises reverting to use the permanent hardware identifier to facilitate engaging in wireless communication service.

5. The method of claim 4, further comprising transmitting from the UE to a cloud-based computing system a request for assignment to the UE of an incognito hardware identifier, wherein the cloud-based computing system is configured to respond to the request by assigning to the UE the temporary hardware identifier for use by the UE in place of the permanent hardware identifier,
wherein the automatically reverting from the incognito mode to the default mode further comprises transmitting from the UE to the cloud-based computing system a message indicating that the UE is finished with use of the temporary hardware identifier, wherein the cloud-based computing system is configured to respond to the message by releasing the temporary hardware identifier for assignment to another UE.

6. The method of claim 1, wherein:
the first operational eSIM profile is for service from a first mobile network operator; and
the second operational eSIM profile is for service from a second mobile network operator different than the first mobile network operator.

7. The method of claim 1, wherein the deactivating of the second operational eSIM profile in the eSIM comprises deleting the second operational eSIM profile from the eSIM.

8. The method of claim 1, wherein the detecting of the trigger for the UE to temporarily operate in the incognito mode comprises detecting that a current geolocation of the UE satisfies a predefined location condition.

9. The method of claim 8, wherein the automatically reverting from operating in the incognito mode to operating in the default mode after operating in the incognito mode for a time period comprises:
detecting that the current geolocation of the UE no longer satisfies the predefined location condition; and
responsive to detecting that the current geolocation of the UE no longer satisfies the predefined location condition, automatically reverting from operating in the incognito mode to operating in the default mode.

10. The method of claim 1, wherein the detecting of the trigger for the UE to temporarily operate in the incognito mode comprises detecting that a current time satisfies a predefined time condition.

11. The method of claim 1, wherein the detecting of the trigger for the UE to temporarily operate in the incognito mode comprises detecting receipt into the UE of user input defining a request for the UE to temporarily operate in the incognito mode.

12. The method of claim 1, further comprising pre-storing in the eSIM the second operational eSIM profile in anticipation of the detecting of the trigger, wherein the activating of the second operational eSIM profile comprises activating the pre-stored second operational eSIM profile.

13. The method of claim 1, wherein the transitioning by the UE to operating in the incognito mode further comprises (i) downloading by the UE the second operational eSIM profile and (ii) storing in the eSIM the downloaded second operational eSIM profile, wherein the activating of the second operational eSIM profile comprises activating the downloaded second operational eSIM profile.

14. The method of claim 1, wherein the first operational eSIM profile also has a first phone number that the UE is configured to use in the default mode to facilitate engaging in telephony service, and wherein the second operational eSIM profile also has a second phone number that is different than the first phone number and that the UE is configured to use in the incognito mode to facilitate engaging in telephony service.

15. A user equipment device (UE) comprising:
a processor;
an embedded subscriber interface module (eSIM);
a transceiver; and
an antenna structure supporting air-interface communication;
a non-transitory data storage holding program instructions executable by the processor to cause the UE to carry out operations including:
detecting a trigger for the UE to temporarily operate in an incognito mode, wherein, when the trigger is detected, the UE is operating in a default mode in which a first operational eSIM profile having a first subscriber identifier is active in the eSIM; and
responsive to detecting the trigger, (i) transitioning from operating in the default mode to operating in the incognito mode, and (ii) after operating in the incognito mode for a time period, automatically reverting from operating in the incognito mode to operating in the default mode,
wherein the transitioning comprises (a) deactivating the first operational eSIM profile in the eSIM and activating in the eSIM a second operational eSIM profile in place of the first operational eSIM profile, wherein the second operational eSIM profile has a second subscriber identifier different than the first subscriber identifier and has not been previously active in the eSIM, and (b) per the second operational eSIM profile, using the second subscriber identifier to facilitate engaging in wireless communication service, and
wherein the automatically reverting comprises (a) deactivating the second operational eSIM profile in the eSIM and reactivating in the eSIM the first operational eSIM profile in place of the second operational eSIM profile, and (b) per the first operational eSIM profile, using the first subscriber identifier to facilitate engaging in wireless communication service.

16. The UE of claim 15, wherein the automatically reverting from operating in the incognito mode to operating in the default mode after operating in the incognito mode for a time period comprises:
detecting a passage of the time period of the UE operating in the incognito mode; and
responsive to detecting the passage of the time period of the UE operating in the incognito mode, automatically reverting from operating in the incognito mode to operating in the default mode.

17. The UE of claim 15, wherein:
the UE has a permanent hardware identifier of the UE that the UE uses in the default mode to facilitate engaging in wireless communication service;
the UE, in the incognito mode, uses a temporary hardware identifier in place of the permanent hardware identifier to facilitate engaging in wireless communication service; and
the automatically reverting from the incognito mode to the default mode further comprises reverting to use the permanent hardware identifier to facilitate engaging in wireless communication service.

18. The UE of claim 15, wherein the detecting of the trigger for the UE to temporarily operate in the incognito mode comprises detecting at least one context state selected from the group consisting of (i) a current geolocation of the UE satisfying a predefined location condition and (ii) a current time satisfying a predefined time condition.

19. A non-transitory computer-readable medium having stored thereon instructions executable by a processor to cause a user equipment device (UE) to carry out operations comprising:
detecting a trigger for the UE to temporarily operate in an incognito mode, wherein the UE has an embedded subscriber interface module (eSIM), and wherein, when the trigger is detected, the UE is operating in a default mode in which a first operational eSIM profile having a first subscriber identifier is active in the eSIM; and
responsive to detecting the trigger, (i) transitioning from operating in the default mode to operating in the incognito mode, and (ii) after operating in the incognito mode for a time period, automatically reverting from operating in the incognito mode to operating in the default mode,
wherein the transitioning comprises (a) deactivating the first operational eSIM profile in the eSIM and activating in the eSIM a second operational eSIM profile in place of the first operational eSIM profile, wherein the second operational eSIM profile has a second subscriber identifier different than the first subscriber identifier and has not been previously active in the eSIM, and (b) per the second operational eSIM profile, using the second subscriber identifier to facilitate engaging in wireless communication service, and
wherein the automatically reverting comprises (a) deactivating the second operational eSIM profile in the eSIM and reactivating in the eSIM the first operational eSIM profile in place of the second operational eSIM profile, and (b) per the first operational eSIM profile, using the first subscriber identifier to facilitate engaging in wireless communication service.

20. The non-transitory computer-readable medium of claim 19, wherein:
the UE has a permanent hardware identifier of the UE that the UE uses in the default mode to facilitate engaging in wireless communication service;
the UE, in the incognito mode, uses a temporary hardware identifier in place of the permanent hardware identifier to facilitate engaging in wireless communication service; and
the automatically reverting from the incognito mode to the default mode further comprises reverting to use the permanent hardware identifier to facilitate engaging in wireless communication service.
